(19) United States
(12) Patent Application Publication
(10) Pub. No.: US 2011/0154409 A1
(43) Pub. Date: Jun. 23, 2011

(54) METHOD AND SYSTEM TO PROVIDE VIDEO ON DEMAND (VoD) SERVICE USING CONTENTS HAVING MULTIPLE BITRATES

(75) Inventors: Eun Jun RHEE, Daejeon (KR); Hyun Woo LEE, Daejeon (KR); Won RYU, Daejeon (KR)

(73) Assignee: Electronics and Telecommunications Research Institute, Daejeon (KR)

(21) Appl. No.: 12/888,987

(22) Filed: Sep. 23, 2010

(30) Foreign Application Priority Data
Dec. 21, 2009 (KR) 10-2009-0128007

(51) Int. Cl. H04N 7/16; H04N 7/173

(52) U.S. Cl. 725/62; 725/95

(57) ABSTRACT

Provided is a method and system of providing a Video on Demand (VoD) service using contents of multiple bitrates that may provide a content encoded at a different bitrate according to a bandwidth of each access network and thereby prevent quality degradation occurring due to a limit of a bandwidth.

### CROSS-REFERENCE TO RELATED APPLICATION

This application claims the benefit of Korean Patent Application No. 10-2009-0128007, filed on Dec. 21, 2009, in the Korean Intellectual Property Office, the disclosure of which is incorporated herein by reference.

### BACKGROUND

1. Field of the Invention

The present invention relates to a method and system for providing a Video on Demand (VoD) service, and more particularly, to a method and system for providing a seamless VoD service when a mobile terminal performs a handover between different radio access networks.

2. Description of the Related Art

A mobile communication system may use an access network having a different bandwidth depending on a region.

However, in communication, a still image or a text may not be greatly affected by a change in a bandwidth. However, in the case of a motion picture, a screen quality may significantly change according to the change in the bandwidth.

For example, when a mobile terminal receives a VoD service while performing a handover between different access networks, the mobile terminal may not verify information regarding a bandwidth and like with respect to an access network. Accordingly, the mobile terminal may not use a content of a high bitrate over an access network having a low bandwidth. Due to a limit of the bandwidth, a packet loss or a transport delay may occur in the access network and thus, the quality degradation such as a black screen phenomenon, a picture distortion phenomenon, and the like may occur.

As another example, even though a transmission bandwidth is sufficient, the mobile terminal may transmit a content of a significantly low bitrate. In this instance, the mobile terminal may have some constraints in using a VoD service of an optimal quality that may be available by the mobile terminal.

Accordingly, there is a desire for a method that may provide a VoD service optimized for an access network to move to when the mobile terminal performs a handover between different access networks.

### SUMMARY

An aspect of the present invention provides a method and system for providing a Video on Demand (VoD) service using contents of multiple bitrates that may transmit, to a mobile terminal, a content optimized for an access network accessed by the mobile terminal, by storing and managing contents having different bitrates according to a bandwidth of each access network.

Another aspect of the present invention also provides a method and system for providing a VoD service using contents of multiple bitrates that may provide a VoD service regardless of a change in a bandwidth of an access network occurring due to a handover between different access networks, by providing, to a mobile terminal, a content having the same description and having a bitrate optimized for a corresponding access network when the mobile terminal performs the handover between the different access networks while using the VoD service.

According to an aspect of the present invention, there is provided a method of providing a VoD service using contents of multiple bitrates, the method including: storing and managing a plurality of VoD contents having different bitrates in correspondence to different types of access networks; receiving a service registration request signal from a mobile terminal via a gateway managing a corresponding access network, and transmitting the received service registration request signal to a mobility management server; receiving network type information associated with a type of the access network managed by the gateway, the network type information being transmitted from the mobility management server in response to the service registration request signal; receiving a VoD content request signal from the mobile terminal; selecting, by a VoD server, a VoD content having a bitrate optimized for the access network, based on the network type information and the VoD content request signal; and providing, to the mobile terminal, the selected VoD.

The method may further include: verifying whether a handover is performed by the mobile terminal; verifying whether the network type information is modified, when the handover is performed; selecting, from the management table, a VoD content having a bitrate corresponding to the modified network type information, when the network type information is modified; and providing, to the mobile terminal, the VoD content having the bitrate corresponding to the modified network type information.

Also, the method may further include: suspending a progress of a VoD content being provided to the mobile terminal, when the network type information is modified; storing a state of the progress; adjusting a start location of the VoD content having the bitrate corresponding to the modified network type information, based on the state of the progress; and executing and thereby providing, to the mobile terminal, the VoD content of which the start location is adjusted.

According to another aspect of the present invention, there is provided a system for providing a VoD service system using contents of multiple bitrates, the system including: a VoD server to manage a plurality of VoD contents having different bitrates in correspondent to different types of access networks, to select a VoD content from the plurality of VoD contents when network type information associated with a type of an access network accessed by a mobile terminal is received from a mobility management server, and to provide the selected VoD content to the mobile terminal.

### EFFECT

According to embodiments of the present invention, a method and system for providing a Video on Demand (VoD) service using contents of multiple bitrates may transmit, to a mobile terminal, a content optimized for an access network accessed by the mobile terminal, by storing and managing contents having different bitrates according to a bandwidth of each access network.

Also, according to embodiments of the present invention, it is possible to provide a VoD service regardless of a change in a bandwidth of an access network occurring due to a handover between different access networks, by providing, to a mobile terminal, a content having the same description and having a bitrate optimized for a corresponding access network when the mobile terminal performs the handover between the different access networks while using the VoD service. Accordingly, it is possible to decrease a user quality degradation such as a picture distortion phenomenon and a black screen phenomenon with respect to a content that may occur due to a packet loss and a transfer delay according to the change in the bandwidth of the access network.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of a system for providing a Video on Demand (VoD) service using contents of multiple bitrates according to an embodiment of the present invention;

FIG. 2 is a diagram illustrating an example of a management table according to an embodiment of the present invention;

FIG. 3 is a flowchart illustrating a method of providing a VoD service using contents of multiple bitrates according to an embodiment of the present invention; and

FIG. 4 is a flowchart illustrating a case where a handover is performed in a method of providing a VoD service using contents of multiple bitrates according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

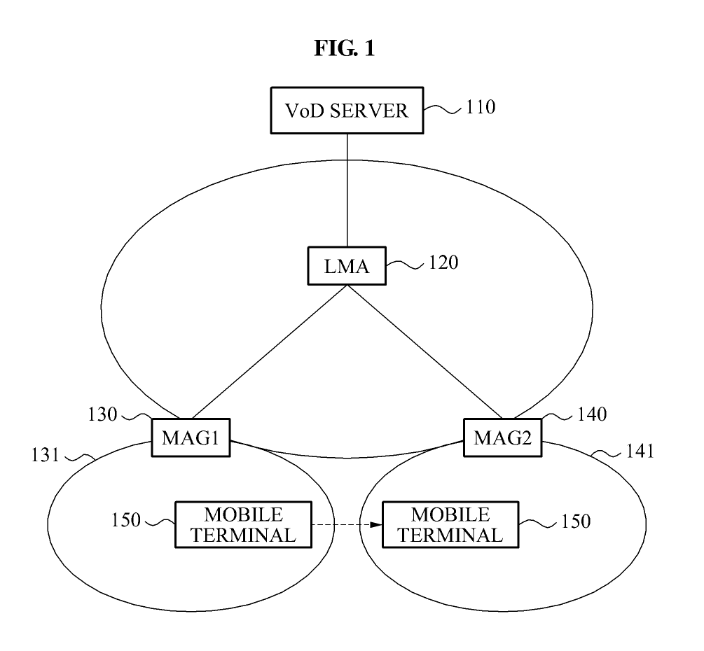

FIG. 1 is a diagram illustrating an example of a system for providing a Video on Demand (VoD) service using contents of multiple bitrates according to an embodiment of the present invention.

Referring to FIG. 1, the VoD service providing system using the contents of multiple bitrates may include a VoD server 110, a Localized Mobility Anchor (LMA) 120, and a plurality of gateways, for example, a Mobility Access Gateway 1 (MAG1) 130 and a MAG (2) 140.

The VoD server 110 corresponds to a data server managing a plurality of VoD contents having different bitrates.

The plurality of VoD contents having the different bitrates may correspond to contents generated by encoding a VoD content having the same description at different bitrates. Each of the bitrates may correspond to network type information of an access network managed by each gateway.

For example, in the VoD service providing system using the contents of multiple bitrates according to an embodiment of the present invention, when accessible access networks include an access network 131 managed by the MAG (1) 130 and an access network 141 managed by the MAG (2) 140, the VoD server 110 may store and manage contents having bitrates optimized for bandwidths of the access network 131 and the access network 141, for example, two types of bitrates, 5 Mbps and 300 Kbps, with respect to a single media content.

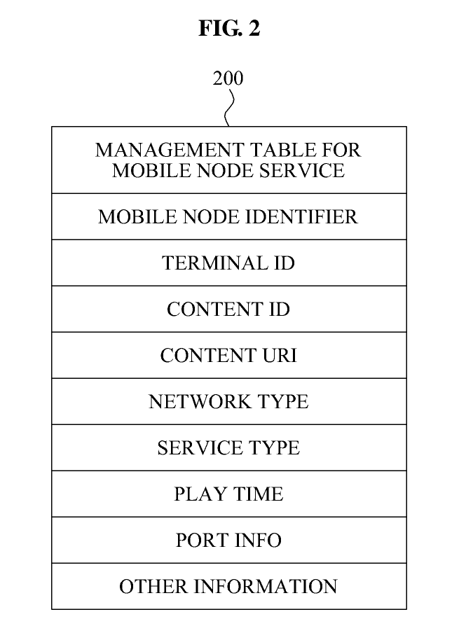

Also, the VoD server 110 may manage a management table 200 for a mobile node service as shown in FIG. 2.

Referring to FIG. 2, the management table 200 may include at least one of a mobile node identifier, a terminal ID, a content ID, a content Universal Resource Identifier (URI), a network type, a service type, a play time, and port information.

In this instance, the content ID corresponds to identification information for identifying a VoD content of a description that is selected by a user from VoD contents stored in the VoD server 110. Specifically, when a plurality of VoD contents, encoded at different bitrates, have the same description, the plurality of VoD contents may have the same content ID.

Also, the content URI corresponds to identification information for identifying each of the VoD contents managed by the VoD server 110. A different content URI may be assigned to each of the VoD contents managed by the VoD server 110. For example, the plurality of VoD contents encoded at different bitrates may have the same content ID, however, may have different content URIs.

The network type information is associated with a type of an access network corresponding to a corresponding VoD content. The service type may correspond to identification information of a service type provided by the VoD server 110. For example, the service type may be a VoD service, a real-time service, and the like.

The network type information may be matched with at least one content URI.

The VoD server 110 may select a VoD content having a bitrate corresponding to a type of an access network accessed by a mobile terminal 150, from VoD contents selected by a user from the management table 200, and may provide the selected VoD content to the mobile terminal 150.

Specifically, the VoD server 110 receiving a VoD content request signal containing information associated with a content selected by the user may search the management table 200 for a content ID corresponding to the VoD content request signal, and may select, from VoD contents corresponding to the VoD content request signal and having the same content ID, a VoD content having a bitrate corresponding to network type information associated with a type of an access network managed by a gateway, and may provide the selected VoD content to the mobile terminal 150.

Also, when the handover is performed by the mobile terminal 150, the VoD server 110 may verify whether the network type information is modified. When the network type information is modified, the VoD server 110 may select, from the management table 200, a VoD content having a bitrate corresponding to the modified network type information, and provide the selected VoD content to the mobile terminal 150.

When the network type information is modified, the VoD server 110 may suspend a progress of a VoD content being provided to the mobile terminal 150, and may store a state of the progress.

The VoD server 110 may adjust a start location of the VoD content having the bitrate corresponding to the modified network type information, based on the state of the progress, and may execute and provide, to the mobile terminal, the VoD content of which the start location is adjusted.

Hereinafter, a case where a type of the access network 131 managed by the MAG (1) 130 is different from a type of the access network 141 managed by the MAG (2) 140, and the mobile terminal 150 performs a handover from the access network 131 to the access network 141 will be described.

Initially, the VoD server 110 may suspend a progress of a VoD content having a bitrate optimized for the access network 131, which is provided to the mobile terminal 150, and may store a state of the progress such as a progress time, information associated with an image at a point in time when the progress is suspended, and the like.

The VoD server 110 may select, from the management table 200, a VoD content having a bitrate optimized for the access network 141.

The VoD server 110 may adjust a start location of the VoD content having the bitrate optimized for the access network 141. Specifically, when the VoD content having the bitrate optimized for the access network 131 is played for four minutes, the VoD content having the bitrate optimized for the access network 141 may be adjusted to be played from a portion corresponding to a point in time where the four minutes has elapsed.

The VoD server 110 may execute and thereby provide, to the mobile terminal 150, the VoD content of which the start location is adjusted.

The LMA 120 may transmit, to the VoD server 110, a VoD content request signal and network type information associated with a type of an access network managed by each gateway.

Specifically, when the LMA 120 receives the VoD content request signal from a gateway, the LMA 120 may transmit, to the VoD server 110, the received VoD content request signal and network type information associated with an access network of the gateway transmitting the VoD content request signal.

Also, the LMA 120 may perform a HA function.

Gateways, for example, the MAG (1) 130 and the MAG (2) 140 may manage different types of access networks, for example, the access networks 131 and 141, and thus may perform as a proxy for three-layered location management of the mobile terminal 150.

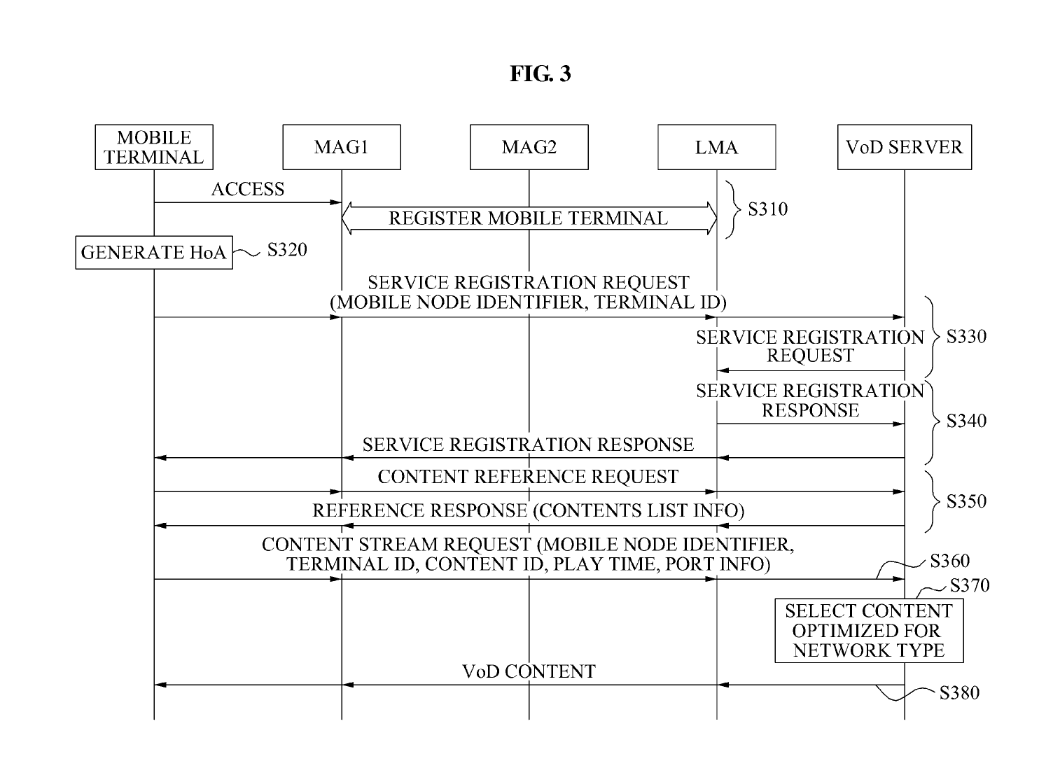

FIG. 3 is a flowchart illustrating a method of providing a VoD service using contents of multiple bitrates according to an embodiment of the present invention.

In operation S310, when a mobile terminal accesses an access network, an MAG1 that is a gateway of the access network may perform an initial mobility registration procedure with an LMA.

Specifically, when the mobile terminal accesses a Point of Attachment (PoA) positioned with the access network, the MAG1 may recognize that the mobile terminal accesses the PoA, and may obtain an identifier of the mobile terminal. In this instance, the MAG1 may transmit, to the LMA, a Proxy Binding Update (PBU) message containing the identifier of the mobile terminal and a Care of Address (CoA). The CoA indicates location information of the mobile terminal.

Also, the LMA receiving the PBU message may generate binding information associated with the identifier of the mobile terminal and the CoA, may establish a tunnel with the MAG1, and may respond to the MAG1 using a Proxy Binding Acknowledgement (PBA) message.

The MAG1 receiving the PBA message may complete the initial mobility registration procedure by transmitting, to the mobile terminal, a Router Advertisement (RA) message. The RA message may contain home network prefix information for the mobile terminal.

In operation S320, the mobile terminal 150 may generate a Home Address (HoA) according to the initial mobility registration procedure. Specifically, the mobility terminal may generate the HoA of the mobile terminal by extracting a home network prefix from the received RA message.

In operation S330, the mobile terminal may transmit a service registration request signal to a VoD server by executing a VoD service application program according to a user input. For example, the mobile terminal may transmit the service registration request signal via the MAG1 and the LMA.

In operation S330, the VoD server may perform a service registration request by transmitting the received service registration request signal to the LMA.

The service registration request signal may include information regarding a content ID of a content selected by a user, a mobile node identifier, and a terminal ID.

In operation S340, the LMA may store a service registration state in a binding table of the mobile terminal, and may transmit the service registration state and network type information of the access network accessed by the mobile terminal as a response. In this instance, the VoD server may transmit the received service registration state to the mobile terminal.

In operation S350, when the VoD server requests a content reference, the VoD server may return, as a response, contents list information managed by the VoD server.

In this instance, the contents list information may correspond to a list of VoD contents having different descriptions.

In operation S360, the VoD server may receive, from the mobile terminal, a VoD content stream request signal for a VoD content selected by the user.

In operation S370, the VoD server may select a VoD content having a bitrate corresponding to the network type information received in operation S340, from VoD contents having the content ID corresponding to the VoD content request signal received in operation S360.

In operation S380, the VoD server may provide the selected VoD content to the mobile terminal.

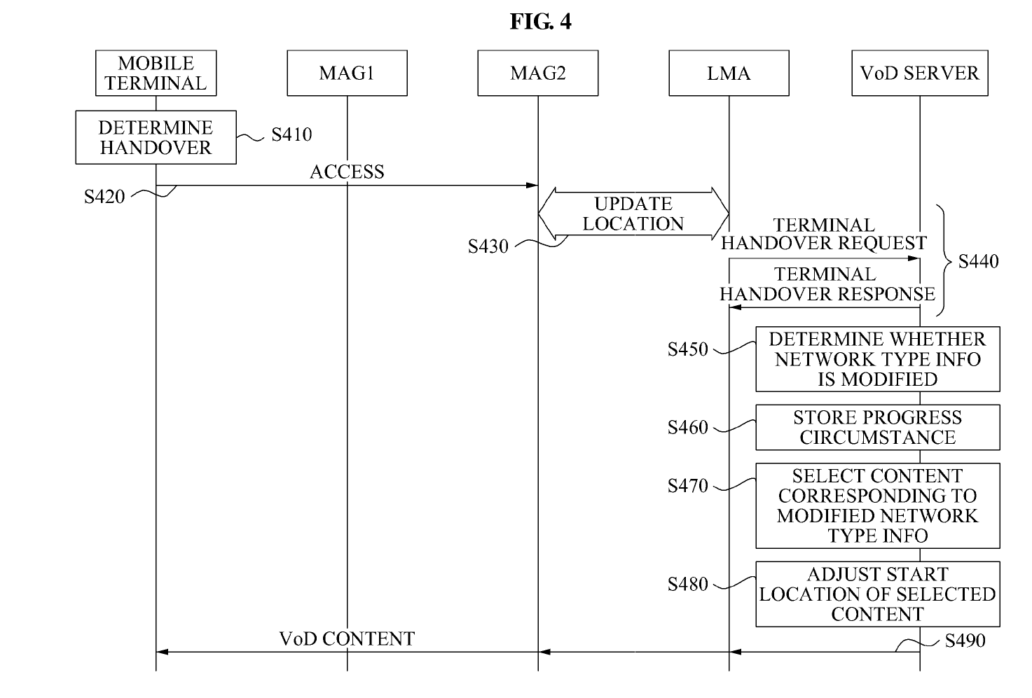

FIG. 4 is a flowchart illustrating a case where a handover is performed in a method of providing a VoD service using contents of multiple bitrates according to an embodiment of the present invention.

In operation S410, when a mobile terminal desires to move to an area of a new access network, the mobile terminal may determine a handover.

In operation S420, the mobile terminal may access an MAG2 of the new access network.

In operation S430, the MAG2 may upload, to an LMA, information regarding that the mobile terminal accessed in operation S420 has moved to the new access network and thereby updates a location of the mobile terminal.

In operation S440, the LMA may transmit a terminal handover request signal to the VoD server. The terminal handover request signal may include at least one of a mobile node identifier, a terminal ID, and network type information.

In operation S440, the VoD server may respond to the terminal handover request signal.

In operation S450, the VoD server may determine whether the network type information is modified due to the handover. In the present embodiment, since an access network is changed from an access network of the MAG1 to the access network of the MAG2, the VoD server may determine that the network type information is modified.

In operation S460, the VoD server may suspend a progress of the VoD content being provided to the mobile terminal in operation S380 of FIG. 3, and store a state of the progress.

In operation S470, the VoD server may select, from a management table, a VoD content having a bitrate corresponding to the modified network type information. For example, the VoD server may select, from the management table, a VoD content having a bitrate corresponding to network type information of the access network of the MAG2.

In operation S480, the VoD server may adjust a start location of the selected VoD content. For example, when a VoD content having a bitrate optimized for the access network of the MAG1 is played for four minutes, the VoD server may adjust the VoD content having the bitrate optimized for the access network of the MAG1 to be played from a portion corresponding to a point in time where the four minutes has elapsed.

In operation S490, the VoD server may execute and thereby provide, to the mobile terminal, the VoD content of which the start location is adjusted.

According to embodiments of the present invention, a VoD service providing system using contents of multiple bitrates may transmit, to a mobile terminal, a content optimized for an access network accessed by the mobile terminal, by storing and managing contents having different bitrates according to a bandwidth of each access network.

Also, according to embodiments of the present invention, when performing a handover between different access networks while using a VoD service, it is possible to provide, to a mobile terminal, a content having the same description and having a bitrate optimized for a corresponding access network. Accordingly, it is possible to decrease a packet loss occurring due to a change in a bandwidth of the access network.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of providing a Video on Demand (VoD) service using contents of multiple bitrates, the method comprising:
storing and managing a plurality of VoD contents having different bitrates in correspondence to different types of access networks;
receiving a service registration request signal from a mobile terminal via a gateway managing a corresponding access network, and transmitting the received service registration request signal to a mobility management server;
receiving network type information associated with a type of the access network managed by the gateway, the network type information being transmitted from the mobility management server in response to the service registration request signal;
receiving a VoD content request signal from the mobile terminal;
selecting, by a VoD server, a VoD content having a bitrate optimized for the access network, based on the network type information and the VoD content request signal; and
providing, to the mobile terminal, the selected VoD.

2. The method of claim 1, wherein:
the plurality of VoD contents having the different bitrates correspond to contents generated by encoding a VoD content having the same description at different bitrates, and
each of the bitrates corresponds to the network type information.

3. The method of claim 1, wherein the VoD server stores and manages the plurality of VoD contents using a management table comprising:
a content identifier (ID) to identify a content having the same description and being encoded at a different bitrate among VoD contents stored in the VoD server;
a content Universal Resource Identifier (URI) to identify each of the VoD contents stored in the VoD server; and
network type information corresponding to each of the VoD contents.

4. The method of claim 3, wherein the network type information matches at least one content URI.

5. The method of claim 3, wherein the plurality of VoD contents having the different bitrates have the same content ID and different content URIs.

6. The method of claim 3, wherein the selecting comprises:
searching the management table for a content ID corresponding to the VoD content request signal; and
selecting a VoD content having a bitrate corresponding to the network type information, from VoD contents corresponding to the VoD content request signal and having the same content ID.

7. The method of claim 3, further comprising:
verifying whether a handover is performed by the mobile terminal;
verifying whether the network type information is modified, when the handover is performed;
selecting, from the management table, a VoD content having a bitrate corresponding to the modified network type information, when the network type information is modified; and
providing, to the mobile terminal, the VoD content having the bitrate corresponding to the modified network type information.

8. The method of claim 7, further comprising:
suspending a progress of a VoD content being provided to the mobile terminal, when the network type information is modified; and
storing a state of the progress.

9. The method of claim 8, wherein the providing comprises:
adjusting a start location of the VoD content having the bitrate corresponding to the modified network type information, based on the state of the progress; and
executing and thereby providing, to the mobile terminal, the VoD content of which the start location is adjusted.

10. A system for providing a VoD service system using contents of multiple bitrates, the system comprising:
a VoD server to manage a plurality of VoD contents having different bitrates in correspondent to different types of access networks, to select a VoD content from the plurality of VoD contents when network type information associated with a type of an access network accessed by a mobile terminal is received from a mobility management server, and to provide the selected VoD content to the mobile terminal.

11. The system of claim 10, wherein:
the plurality of VoD contents having the different bitrates correspond to contents generated by encoding a VoD content having the same description at different bitrates, and
each of the bitrates corresponds to the network type information.

12. The system of claim 10, wherein the VoD server stores and manages the plurality of VoD contents using a management table comprising:
a content ID to identify a content having the same description and being encoded at a different bitrate among VoD contents stored in the VoD server;
a content URI to identify each of the VoD contents stored in the VoD server; and
network type information corresponding to each of the VoD contents.

13. The system of claim 12, wherein the network type information matches at least one content URI.

14. The system of claim 12, wherein the plurality of VoD contents having the different bitrates have the same content ID and different content URIs.

15. The system of claim 12, wherein the VoD server searches the management table for a content ID corresponding to the VoD content request signal, and selects a VoD content having a bitrate corresponding to the network type information, from VoD contents corresponding to the VoD content request signal and having the same content ID.

16. The system of claim 12, wherein:
when a handover is performed by the mobile terminal, the VoD server verifies whether the network type information is modified, and
when the network type information is modified, the VoD server selects, from the management table, a VoD content having a bitrate corresponding to the modified network type information, and provides, to the mobile terminal, the VoD content having the bitrate corresponding to the modified network type information.

17. The system of claim 16, wherein when the network type information is modified, the VoD server suspends a progress of a VoD content being provided to the mobile terminal, and stores a state of the progress.

18. The system of claim 17, wherein when the network type information is modified, the VoD server adjusts a start location of the VoD content having the bitrate corresponding to the modified network type information, based on the state of the progress, and executes and thereby provides, to the mobile terminal, the VoD content of which the start location is adjusted.
